(19) United States
(12) Patent Application Publication
(10) Pub. No.: US 2006/0178941 A1
(43) Pub. Date: Aug. 10, 2006

(54) Method, system, and software for retrieval and analysis of service data

(76) Inventor: John H. Purnell III, Annapolis, MD (US)

Correspondence Address: FOLEY AND LARDNER LLP;SUITE 500, 3000 K STREET NW, WASHINGTON, DC, 20007, US

(21) Appl. No.: 11/049,870

(22) Filed: Feb. 4, 2005

(51) Int. Cl. G06Q 30/00

(52) U.S. Cl. 705/26

(57) ABSTRACT

A method, system, and software retrieving and analyzing service data of a service used by a user, includes accessing by the third party, over a network, the user's account with a service provider of the service to retrieve the service data from the service provider, wherein the third party is a party other than the service provider or the user. The third party analyzes the service data by the third party, and provides results of analyzing the service data.

### FIELD OF THE INVENTION

This invention relates generally to the field of retrieval and analysis of data from multiple sources. More particularly, this invention relates to retrieving both private and publicly available data related to a service used by a user in order to analyze the usage of the service by the user.

### BACKGROUND OF THE INVENTION

Currently, with the advance of deregulation and the march of technology, users of services such as a telephone service (both landline and wireless) or utilities are provided with a vast array of choices in selecting plans for usage of the services. Furthermore, the payment for these services are often based on usage parameters that are very difficult for a user to track in a meaningful manner. Therefore, such users (including both individuals and businesses) often make decisions regarding usage and selection of service plans without properly analyzing all the data that should be factored into their selection decision.

Furthermore, in many instances, it is very difficult for the users to access all the data that is required to make an intelligent decision since the data may be stored in different places, in different formats, or available from different sources which are not conveniently accessible to the user. Accordingly, users often make decisions on their service provider selection and the service provider plan selection (where a service provider offers more than one plan) without a proper analysis of their usage needs or considering all the available service provider options for satisfying their usage needs.

### SUMMARY OF THE INVENTION

In certain embodiments, the present invention provides a computer implemented method of a third party retrieving and analyzing service data of a service used by a user, including: accessing by the third party, over a network, the user's account with a service provider of the service to retrieve the service data from the service provider, wherein the third party is a party other than the service provider or the user; analyzing the service data by the third party; and providing, by the third party, results of analyzing the service data.

In certain embodiments the network may be a public network.

In certain embodiments, the method further includes a step of the third party receiving access information from the user or generating access information on behalf of the user and the step of accessing the user's account includes the third party using the access information to retrieve the service data.

In certain embodiments, the method further includes the steps of: receiving additional information related to the user or the service from a source other than the service provider; and converting the service data and the additional information into a common format, wherein the step of analyzing the service data includes analyzing the service data and the additional information in the common format.

In certain embodiments, the step of receiving access information includes receiving an account number and password used by the user to access service data from the service provider.

In certain embodiments, the step of receiving additional information includes receiving enhancement information related to the service from the user.

In certain embodiments, the step of receiving additional information includes accessing public data related to the service data.

In certain embodiments, the service is a telephone service, the service data includes call details of the user, and the public data includes a reverse lookup data identifying called telephone numbers of the calls in the call details.

In certain embodiments, the public data includes pricing information of the service provider and other competitors of the service provider.

In certain embodiments, the service is a utility service, the service data includes a usage of the utility service per time period, and the public data includes a weather related parameter related to the time period.

In certain embodiments, the service is travel, the service data includes a listing of trips and time periods of the trips, and the public data includes prices of trips during particular time periods provided by the service provider and other competitors of the service provider.

In certain embodiments, the service is a healthcare related service, the service data includes s a listing and prices of the procedures used, and the public data includes pricing information on the procedures used provided by a third party source.

In certain embodiments, the service is automobile maintenance, the service data includes maintenance and cost data of maintenance services performed the user, the public data includes maintenance schedules and pricing data for the maintenance services.

In certain embodiments, the service is a financial service, the service data includes a listing of financial transactions and fees on the user's account, and the public data includes public information related to the listed financial transactions and fees of other service providers.

In certain embodiments, the analyzing step comprises using a quantitative analysis process to compare usage of the service by the user based on plans provided by other service providers or other plans provided by the service provider.

In certain embodiments, the method further includes automatically converting the user to the optimal service plan.

In certain embodiments, the method further includes automatically receiving data related to usage of the service by the user from a source other than the service provider. The source may be a remote sensor that automatically collects data related to usage of the service and automatically transmits the collected data to the third party. If the service is a telephone service, the remote sensor automatically collects call details and periodically transmits the call details to the third party.

In certain embodiments, the present invention provides a system for a third party retrieving and analyzing service data of a service used by a user, including: an interface unit of the third party that accesses the user's account with a service provider of the service over a network and retrieves the service data from the service provider, wherein the third party is a party other than the service provider or the user; an analysis unit, connected to the interface unit, that analyzes the service data; and an output unit that receives analysis results from the analysis unit and provides the analysis results to the user.

In certain embodiments, the present invention provides a computer readable medium having program code recorded thereon that, when executed on a computing system, enables a third party to retrieve and analyze service data of a service used by a user, the program code including: code for accessing by the third party, over a network, the user's account with a service provider of the service and retrieving the service data from the service provider, wherein the third party is a party other than the service provider or the user; code for the third party analyzing the service data; and code for the third party providing results of analyzing the service data.

In certain embodiments, the present invention provides a computer implemented method of analyzing service data of a service used by a user, including: providing, by the user, access information to access service data from a service provider of the service so that service data from the service provider is retrieved by a third party using the provided access information; providing, by the user, additional information related to the service or the user; and receiving an analysis result of the analysis of the service data and the additional information, which are both converted to a common format prior to the analysis, from the third party.

In certain embodiments, the present invention provides a remote sensor for automatically collecting and sending service data related to usage of a service by a user, including: a probe unit that automatically detects service data related to usage of the service; a memory unit that stores the detected service data; and a transmission unit that transmits the stored service data. If the service comprises a telephone service, the probe unit is inserted between a telephone cord and a telephone jack, the service data comprises telephone call details, and the transmission unit comprises a modem.

### BRIEF DESCRIPTION OF THE DRAWINGS

The accompanying drawings, which are incorporated in and constitute a part of the specification, illustrate embodiments of the invention and together with the description, serve to explain the principles of the invention.

FIG. 1 is a flowchart illustrating an exemplary enrollment process.

FIG. 2 is a flowchart that illustrates the pull process to retrieve service data.

FIG. 3 is flowchart that illustrates the step of receiving data from automated sources using a “push” technique.

FIG. 4 is a flowchart that illustrates a generic data enhancement process.

FIG. 5 is a flowchart illustrating the data presentation process in certain embodiments.

FIG. 6 is flowchart that illustrates the analysis process in certain embodiments.

FIG. 7 is flowchart that illustrates one embodiment of the conversion process.

FIG. 8 discloses a high level module system architecture.

FIG. 9 discloses a user navigation system architecture.

FIG. 10 discloses a physical system architecture.

FIG. 11 discloses an example of a remote sensor.

FIG. 12 is a diagram of a generic computing system, connected to a network, that may be used in certain embodiments of the present invention.

### DETAILED DESCRIPTION OF THE EMBODIMENTS

In the context of the present application, the glossary below provides definitions for certain terms that are used in the present application.

Glossary

Account—The specific account that pertains to only one data owner.

Data owner—The person or corporate entity that typically has the right to view its own private data.

Data records—The most discrete data provided by the data source.

Data source—The organization that produces the personal data (or service data) and usually has a contractual relationship with the data owner and creates the information based on the activity of the data owner under that contractual relationship. A data source is always a provider, for example, of a service used by the user.

Personal, private or service data—Information specific to the data owner, typically held in confidence by the data source as the private data of the data owner.

Plan—A specific offering from a provider, typically a provider of services such as a telecommunications or utility service. A provider may have several plans some of which may he applicable to the user's circumstances.

Profile—The information kept by the system specific to a user which is not related to specific data records but contains data source and account information as well as other data not related to the data sources.

Provider or service provider—An organization which offers services in the class of those provided by the data source (which may be one example of a service provider) and whose offerings can be compared to those of the data source.

Public Data—Information that can be obtained publicly without consent from the data owner.

Public Network—A network to which data owners might subscribe to exchange information such as the Internet.

Third Party—A party other than the user or the data source.

User—The person(s) or their agent(s) who interacts with the system and who is also, therefore, the data owner of the data being retrieved and presented or a user of a service provided by a service provider.

User data—Information entered or otherwise provided by the user which is not from the data sources of the system, but is entered or otherwise provided by the user to enhance the data records retrieved.

Applications

The system and method of the present invention may be used in a variety of situations where a user cannot cope with the volume of private data (for example, service data related to a service used by the user) and/or the complexity of analysis of that service data in the context of additional reference data that needs to be accessed and correlated to complete the analysis of the service data. For example, such applications exist in the areas of analyzing data related to (but not limited to): (1) telecommunications services (for example, telephone bills); (2) utility (Gas & electric) services (for example, bill data from the utilities); (3) health records and services; and (4) automotive maintenance records and services. In the immediately following sections, certain embodiments of a process of analysis of such service data is described.

Process

In certain embodiments, the present invention provides a method of analysis of private or service data of a user of service by a third party (that is different from either the user or the service provider) using most or all of the following six basic processes. These basic processes include: (1) Enrollment; (2) Data Retrieval; (3) Data Enhancement; (4) Data Presentation; (5) Analysis and Recommendation; and (6) Service Conversion. These basic processes may be provided by a third party that is party different from the user and the data source or the service provider.

Each of these processes are described next in the following subsections.

Enrollment Process

The enrollment process gathers enough user information to begin the data retrieval process, for example, from the service provider. The enrollment process may include billing and payment arrangements such as storing credit card number and expiry date details. It should be noted that, in certain embodiments, the “retrieval” of data elated to a service provided by a service provider also includes receiving the service data from a source of the service data where the data transmission is initiated by the source of the data. One example of such a data transmission may be sensor which detects or tracks the service data and periodically transmits the service data to a third party that retrieves and analyzes the service data.

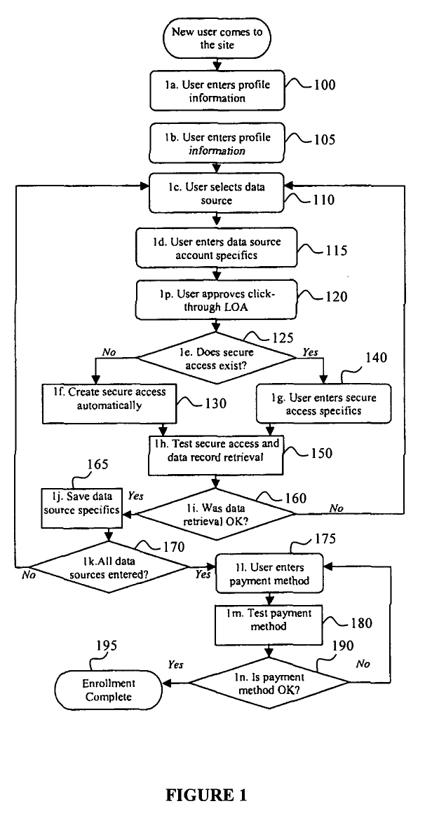

FIG. 1 is a flowchart illustrating an exemplary enrollment process. It should be understood that FIG. 1 is exemplary only and those skilled in the art would recognize various modifications and alternatives, all of which are considered a part of the present invention. Enrollment begins with a new customer who comes to the site (for example, of the third party) and desires to use the service provided by the present invention. In step 100, this user provides general information about themselves and, if a corporate account, information about the corporation. This information would typically include, but is not limited to, name, address, phone number, and email address. If the user is a corporate entity, the information includes corporate name and the names and titles of the authorized users of the system.

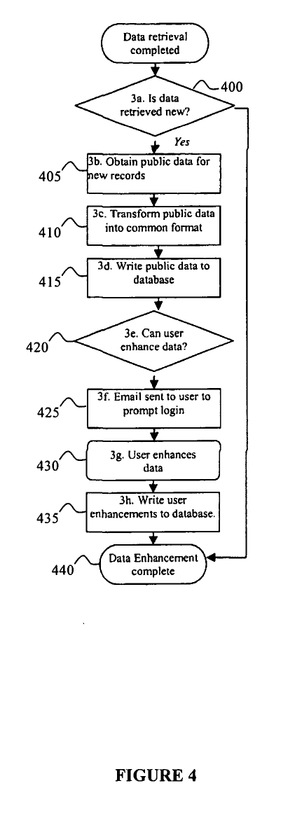

For a specific application in step 105, the user is be allowed to identify public and user data enhancements which will be used to supplement the raw data and add greater meaning in the Data Enhancement process discussed further herein. The identification of these data elements occurs in step 105 while the retrieval/entry of that data is discussed further herein with respect to FIG. 4. See the table in the Data Enhancement section for some application specific examples of data enhancements that may be provided by a user.

The user would then begin the steps related to identifying the locations of their private data. In step 110, the user identifies the data source which would typically be a service provider with whom the user has a contractual relationship. This may be implemented as a pull down menu of the data sources with which the system has a functional interface. In certain embodiments, it would not be possible for a user to create a new data source, but user requests would likely stimulate new interface development based on market demand. In step 115, the user provides the specifics which identify that user's private data in the data source. This would typically be an account number or other similar identification.

The legal right for a consultant to obtain records on behalf of their client is expressed in a Letter of Agency. This letter typically provides limited powers to the consultant by which, in this case, the consultant may only obtain the records. The system accomplishes this, in one embodiment, as shown in step 120, by using a “click-through” letter of agency, much like the click-through license agreements that are well known.

Some data sources require secure access (typically a login and a password) and in some cases, the user will have already established this. The system asks if the user has established secure access (step 125) and if so, then the user is asked for the login and password (step 140). If no previous access has been established, the system may auto-generate login ID and passwords and use those to establish secure access with the data source (step 130).

Next the system test data retrieval from the source (step 150). If the retrieval is successful (step 160), the system saves the new data source for future retrieval (step 165). The system then asks the user if there is other data to be retrieved (step 170) and if so, returns to step 110 for the next data source or else completes the enrollment process in steps 175-195. If the test retrieval fails in step 160, the user is returned to step 110 to re-enter the information for that data source.

Now that the data sources are known to the system the user is asked to provide payment information in step 175. In many embodiments, this will be a credit card, but other payment options (such as automatic deduction from a checking account) may be offered. If the pricing of the service is based on the number of data sources or the data retrieved, this step may also include presenting the user with pricing information. The payment mechanism is tested (step 180) and if it is approved (step 190), then the enrollment process is completed in step 195. If there is a problem, the user is returned to the payment method entry step 175.

This same process would be used for existing users who wish to modify their enrollment information. Instead of entering account information, the users could view and edit their information in step 100. In step 110 and 115, existing users could add new data sources, delete data sources with which the user no longer has a relationship, or modify data sources which have changed. In step 175, the user may change the form of payment (this would include updating expiry of credit cards). All of the other steps would be the same for both new and existing users. The enrollment process may also contain an service cancellation capability for users to terminate their relationship with the service provided by the present invention.

Users can modify the enhanced data types which are provided in step 105 and then add any user enhanced data in step 430 (of FIG. 4) during the next data enhancement session.

The following table provides examples of services together with their data sources (or service providers) and service data information (accounts and data records).

| | Data Sources | Accounts | Data Records |
|---|---|---|---|
| Telephony | Telecommunications providers such as | Telephone numbers on | Call detail records showing date, time, |
| | Verizon, AT&T, Sprint, MCI, etc. | specific billing plans | duration, called number, etc. and |
| | | | the monthly bill summary data |
| Energy | Gas and Electricity suppliers such as | Billing by property | Monthly usage, rates, |
| | BG&E, PPL, PEPCO, Washington | location and/or commodity type | actual vs. estimated |
| | Gas, etc. | | and billing summaries |
| Health | Health providers such as doctors, | Specific patient accounts, | Records of visits or admittance/discharge, |
| | hospitals, specialists, etc. | perhaps by case | diagnoses, X-rays, prescriptions, vital |
| | | | sign readings, etc. |
| Automotive | Dealers, repair | Records for a | Dates of services, service tasks done, |
| | shops, oil/lube stores | specific vehicle | parts replaced, odometer and |
| | | | other readings |

Data Retrieval

In certain embodiments, the present invention provides at least two techniques for collecting the raw data (for example, the service data related to a user from a service provider). One is a “pull” process from the data sources. The second is a “push” process from automated sources of data, such as remote sensors.

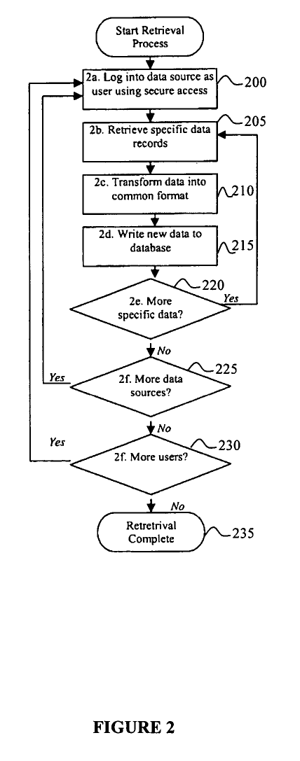

The pull process occurs on regular intervals, for example, once a day. FIG. 2 is a flowchart that illustrates the pull process to retrieve service data. Each user's data is sequentially retrieved from each data source using the secure access setup from enrollment. The process begins with the system logging into the data source using the information provided by the user (step 200). The system then retrieves private data from the data source (step 205) in the format of the data source. This data must be converted to a common format using, customized conversion software or using or adapting commercially available transformation software (step 210) which maps fields from one format to another. For example, the data may be in a self documenting XML format that facilitates a conversion to a common format. This converted data, now normalized, can be written into a database in step 215. In steps 220-230, this data retrieval process is iterated for other specific data from the data source, other data sources for that user, and for other users before the data retrieval is completed in step 235.

In certain embodiments, retrieval process is performed on a regular periodic basis, but it may run for a specific user's data source on a less frequent basis. For example, while the retrieval process may run nightly for many users or applications, the retrieval of data from a specific account for a specific user may occur only once per month.

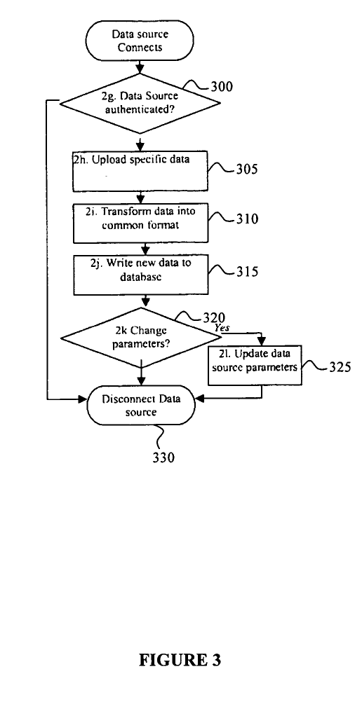

FIG. 3 is flowchart that illustrates the step of receiving data from automated sources using a “push” technique. The push process is typically reserved for remote sensors, but might apply to some other data sources, for example, using automated transmissions of data using a computer network. For example, in the context of financial transactions, any transaction entered into a financial software package, such as Quicken, may trigger an automated transmission of that transaction information to the system. In both cases, there are called data sources. A remote sensor could connect via an analog dial-up connection or via an internet protocol session. Remote sensors may typically be used to get personal data that cannot be obtained from a service provider or if the service provider does not provide data with sufficient details.

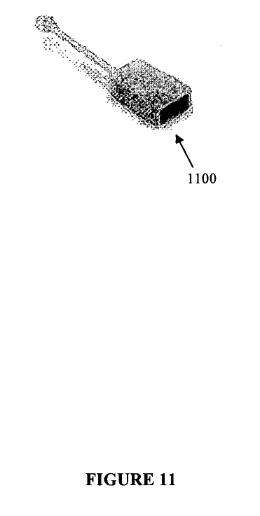

The push process begins with the data source (which is used here to generically describe the remote device or sensor) initiating connection into the central system and database. In step 300, the system authenticates the device (or sensor) attempt to transmit the data, for example, by using public key infrastructure where the public key resides in the data source and the private key in the central system. If the data source cannot be authenticated, it is disconnected, thus preventing the introduction of corrupt data into the system. If authenticated, the data source then uploads the data (step 305). This data may then need transformation to the common database format (step 310) and is written to the database in step 315. Since this is a chance to communicate with a remote device, the central system may download parameters to a remote device in steps 320 and 325 and then disconnect the remote device in step 330. The parameters downloaded may include the interval with which the remote device or sensor communicates or the data it retains and uploads. See FIG. 11 and its description further herein for one example of a such a remote device.

Data Enhancement

Data enhancement increases the value of the raw data through integration with publicly available data and data understood by the user which is not easily electronically accessible. Data enhancement is highly application specific, however, a generic process is shown in the flowchart of FIG. 4.

The first step immediately follows the retrieval of data. Information which enhances the specific records is retrieved and stored with the raw data. In step 400, the data retrieved is examined to determine whether it is new (i.e. does the system already have enhancements for this data).

For that data which is new, in step 405, system enhances the data with publicly available data in accordance with the user's selections from step 105 (as discussed with respect to FIG. 1). This can typically be done immediately, or at least as expediently as the relevant public data sources are available. The public data is electronically retrieved, transformed to the common database format and written into the database in steps 410 and 415 in such a way that it can be easily associated with the raw data.

However, some data to be associated with the new data is not publicly available. If user enhancements are desired, the user is notified that new data is present in the system and the user is prompted to enter the user enhancements in steps 420 and 425. The user is not required to do enhance the data at any specific timeframe, or for that matter, at all. However, users that fall behind on enhancing the data will find less value in the system.

The following table presents examples of public and user data enhancements that may be made for specific services (telephony, utility, health, and automotive) that may be used by a user.

| | Public Data | |
|---|---|---|
| | Enhancement | User Data Enhancement |
| Telephony | Reverse directory | Categorization (e.g. |
| | lookup of called | “Business,” |
| | number, federal or | “Personal”, or |
| | state holidays | “Charitable”), |
| | | specific numbers |
| | | not to be dialed |
| Utility | Weather specifics | Business activity |
| (Energy) | for the site | which might |
| | | drive energy |
| | | consumption |
| Health | Pharmacology | Wellness, symptoms |
| | information | observed at home |
| Automotive | Maintenance guides | Odometer readings, |
| | for the vehicle | fuel purchases |

Data Presentation

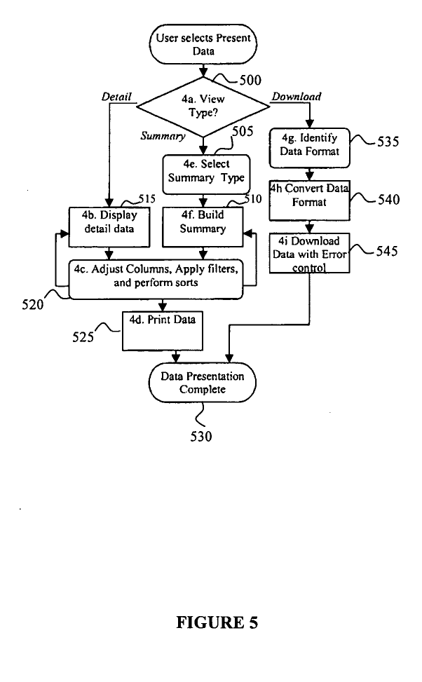

FIG. 5 is a flowchart illustrating the data presentation process in certain embodiments. In these embodiments, the presentation of the data to the user involves the user selecting between three view types (step 500): Detail, Summary, and Download. The first two of these are viewed by the user on the screen and may be printed as seen on the screen. The latter is a download of the data to a file on the user's computer so that the user may perform custom analysis on the downloaded data.

If the user selects Detail, the raw data is displayed on the screen (step 515). The user may then add, delete, or change the order of the columns, filter the data, or sort it in a way meaningful to the user (step 520). This process is iterative until the user is satisfied with the format and may chose to print the report (step 525).

If the user elects Summary report, he will also select a type of summary (step 505). This summary type is dependent upon the application, but in all cases will distill the raw data into a more easily understood format. In this step, aside from consolidating the data using simple arithmetic means (e.g. summation and sorting), no additional intelligence has been added to the data. In certain embodiments, this is performed in the Analysis and Recommendations segment that is discussed further herein. The summary report is built (step 510) and the user again has the ability to make adjustments to the display of data (step 520). This process then iterates until the user prints the data (step 525).

More sophisticated users may want to subject the data to their own reporting rigors, analysis, or integration with other data. This is facilitated via the download feature. The user must choose the data format (step 535)) which will include the data elements from the database, filters, and sorts which are applied to the data before downloading. This step also includes the file format selection (e.g. Comma delimited text file, Excel worksheet, or SQL database). The application then performs the requested conversion (step 540) and transfers the formatted data file to the user's computer using a standard error control transmission procedure (step 545).

The following table lists exemplary summary reports for various services that may be used by a user.

| | Typical Summary Reports |
|---|---|
| Telephony | Most frequently dialed |
| | Most expensive calls |
| | Call volume and cost by time period |
| Energy | Energy consumption by season |
| | Energy consumption summarized by weather |
| Health | Total prescription expense by individual |
| Automotive | Cost per mile |

Analysis and Recommendation

The analysis and recommendation capabilities are very application specific and typically make predictive results. These include, for example, quantitative analysis and artificial intelligence algorithms. The quantitative approaches use finite recalculation of the historical raw data to examine costs and performance under many plans from many service providers. The artificial intelligence approaches use the raw data and a cascading series of interview questions to make recommendations about changes which the user may find improve cost and/or performance or optimize some other parameter (for example, quality of service).

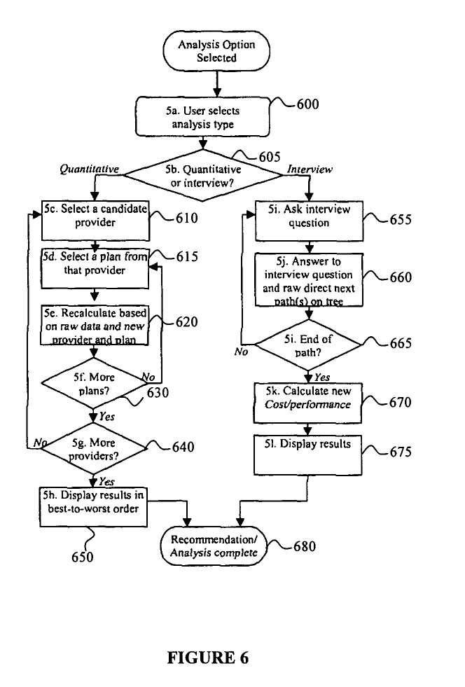

FIG. 6 is flowchart that illustrates the analysis process in certain embodiments. The process begins with the user selecting from a menu of analyses (step 600) that are available for the specific application. If a quantitative analysis is selected in step 605, the process continues with step 610, but if it is an interview analysis, the process begins with step 655.

In certain embodiments, the quantitative analysis is essentially a nested loop that analyzes alternative providers and the plans for each provider. The algorithm starts with the first provider (step 610) and the first plan from that provider (step 615). The user's raw data is then completely reanalyzed under the new plan (step 620) and these results are saved for comparison to the other alternatives. If there are more plans for that provider (step 630), this process repeats and continues until all providers are exhausted (in step 640). The results are then displayed in best to worst order with the user's current plan highlighted for comparison (step 650). This display will typically be the best plan from each provider and the user may then drill down and look at all of the plans from one specific provider.

The artificial intelligence approach uses a non-quantitative or partly quantitative diagnostic tree approach. The user is asked a series of interview questions (step 655) which the system interprets, along with the raw data collected, to identify other possible questions to ask (step 660). When the end of a diagnostic path is reached (step 665) the system calculates the new cost performance compared to the existing cost performance (step 670) and reports the recommendation to the user (step 675) before the analysis and recommendation process is completed in step 680.

Conversion

Following analysis and recommendation, the user may instruct the system to perform a conversion. This process carries out the recommendation from the earlier analysis and recommendation phase. Certain conversions can be accomplished entirely automatically while others will require action on the part of the user. In both cases, however, the system tracks the progress and success of the conversion and measures the actual performance against the predictions made in the previous process.

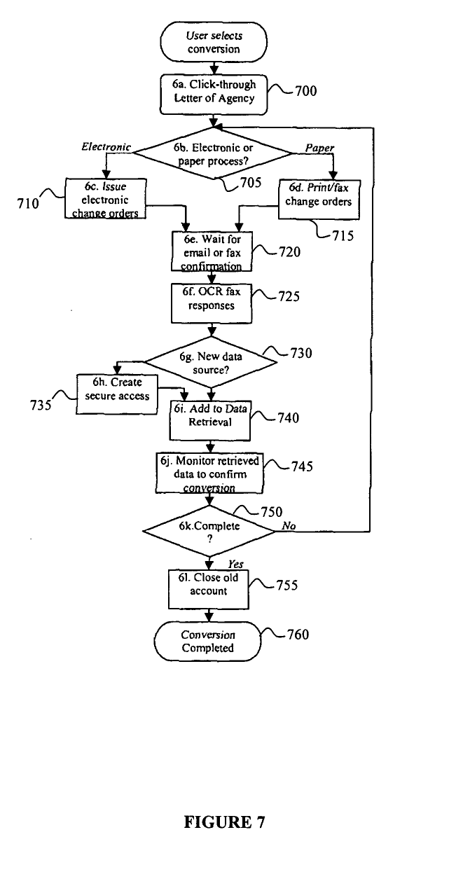

FIG. 7 is flowchart that illustrates one embodiment of the conversion process. As shown in step 700, the initial step is to create a new letter of agency which empowers the system to make the changes required for the recommendation.

The process for filing orders with the service providers may be either electronic (i.e. via web page or email) or paper (letter or fax). The choice of means and the issuance of the orders is shown in steps 705-715.

The system then waits for a fax or email response which indicates the orders are in progress and then completed (step 720). If this is a fax, then the image is subjected to an Optical Character Recognition process to determine the data it contains (step 725).

A new data source requires establishing a new secure access. This is performed in steps 730 and 735. A change of plans with an existing provider may mean that this step can be skipped. These steps are similar to enrollment steps discussed earlier herein and in a similar fashion they extend the database for that user to retrieve data for these new services (step 740). The conversion process monitors the new data sources and accounts to ensure that they are being utilized (step 745).

When the retrieval process confirms that the user is fully utilizing the new service (step 750) and the old service is idle, the system automatically closes out the old service in step 755 to complete the conversion process in step 760.

Technical Architecture

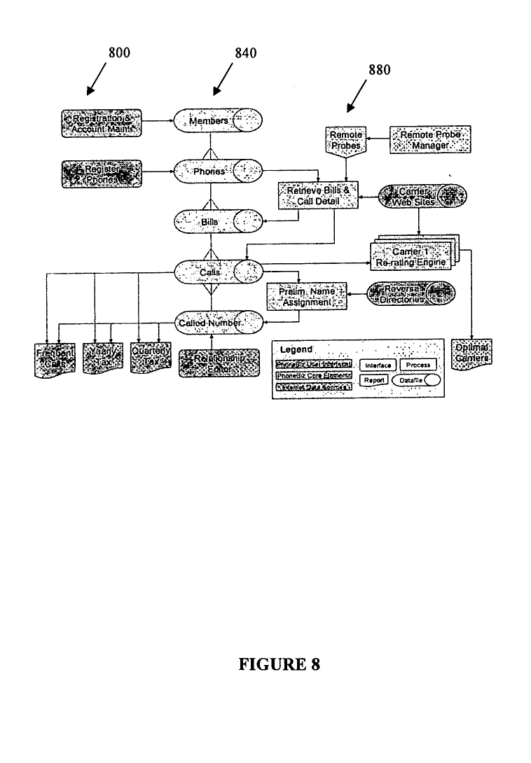

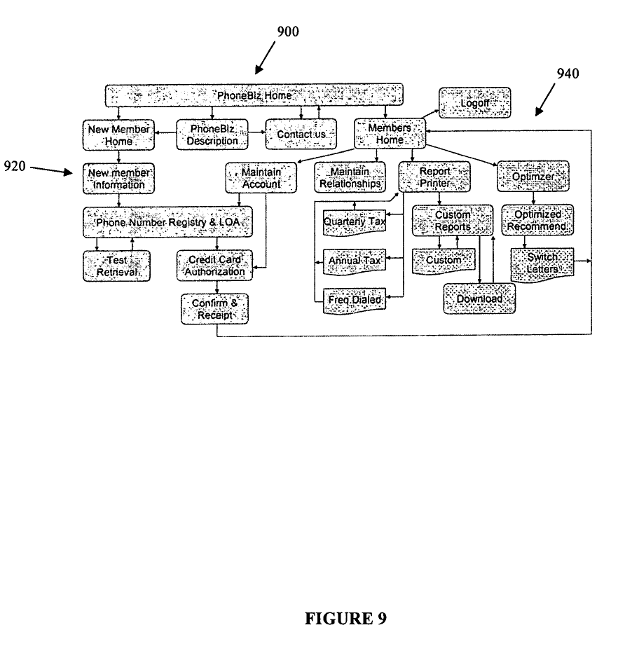

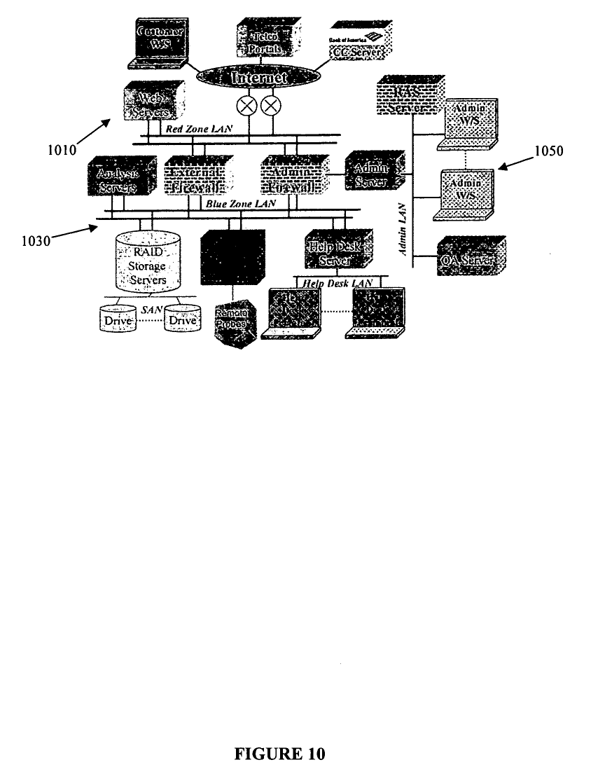

The technical architecture that implements certain embodiments of the present invention is discussed with references to FIGS. 8-10. FIG. 8 discloses a high level module architecture. FIG. 9 discloses a user navigation architecture while FIG. 10 discloses a physical architecture.

The module architecture shows how the software and databases interact with one another at a high level. The user generally interacts with the interface modules (or unit) shown generally as 800. The analysis and output modules (or units) that typically interact asynchronously with user data in the databases (both shown in blue) are shown generally as 840 and the external data sources are shown generally as 880.

In the context of telephony services, the user may enroll and maintain account relationships in one module that holds data that is not specific to the phone lines being analyzed. This may include enrollment data on the primary account holder, login and password information for other authorized users (typically for small business), and the billing information.

The registration of phones module allows the user to enter a specific phone number into the system and handles the Letter of Agency process. The Relationship Editor optionally allows the user to supplement or enhance reverse directory information with data meaningful to themselves. This can include further specificity of name and classification of numbers.

As shown in FIG. 9, in the certain embodiments of the present invention, the user navigates the system in three specific areas. Starting at the Home Page, newcomers to the site will typically explore the “public” areas of site shown generally as 900. These pages provide information of the features of the system provided according to the present invention. It may even include a “Benefit calculator” which prompts the buyer to put some limited information into the system (say the number of phone numbers and average monthly total cost) and provides some level of expectation of savings and other benefits experienced by similarly situated customers. It may include a money-back guarantee of savings.

User that choose to buy enter the new members section of pages indicated generally as 920 in FIG. 9. This is where the account gets set up, the phone lines are registered, and the letters of agency are created. As the customer enters phone numbers, the system actually test the connection to the phone company's billing system. During this session, the billing arrangements are set up and the initial transaction with the card is conducted and a receipt is generated.

Returning customers (or users) are directed to the Members section of the web site indicated generally as 940 in FIG. 9. Here they will have a choice of phone bill analysis, report generation or editing relationships. At any time they may return to the account management section to update personal data and add or delete phone numbers in the system.

As shown in FIG. 10, the system is designed with a high reliability architecture which is delivered through: dual rail production Local Area Networks (LANs) (1010 and 1030); firewall protection from the internet and administrative zones (1050); diverse high speed redundant Internet access; Redundant Arrays of Independent Disks (RAID) disk storage arranged in a Storage Area Network (SAN); modular independent and redundant analytic and web server processors; and a functional replica configured to automatically replace any component that fails. If one of the LANs becomes corrupted, the second rail is designed to take 100% of the traffic. The Internet access has diverse paths to separate Internet Service Providers (ISPs).

This Internet access supports all types of communications between system and the outside world. These communications include customer interactions with the web servers, data retrieval from telephone companies, credit card transactions, voice and chat sessions with the help desk, and administrative purposes such as email and voice over IP for the office staff. Maximizing traffic through these Internet links justifies very large data transmission pipes that eliminates traffic bottlenecks that degrade customer service.

In case, capacity planning fails to predict an overwhelming demand from customers, in certain embodiments, the system is configured with the following traffic priorities (Highest to Lowest): (1) web interaction with customers or users; (2) chat sessions with customers or users; (3) data retrieval from telephone companies or other service providers; (4) credit card transactions; (5) voice sessions with a Help Desk; (6) administrative email; (7) administrative internet browsing; and (8) administrative voice traffic.

The architecture is designed to be modular and scalable to deliver high performance at a low cost.

Lower priority traffic would be delayed until non-peak times, or switched to alternative means (e.g. conventional telephone lines or cell phones).

In certain embodiments, the web servers would use Microsoft IIS as the web interface. The data retrieval subsystem would use custom software to handle the data transformation from various vendor formats to a common data structure. Some data, for example, bills which might be presented in an image file format will go through an Optical Character Recognition (OCR) process first and then through customized conversion process. Some examples of the transformation may include standardizing the time entries in each data record to, for example, a Greenwich mean time (GMT) or time periods may also be standardized to the same format (for example, rounded to the nearest minute). Alternatively, all time periods for a data record may be standardized to an equivalent start and stop time. The translation process may also include validity checks and corresponding context sensitive recovery. For example, the context sensitive recovery may correct errors that may be introduced by the OCR process. As an example, a scanned area code may be correlated to a city and state in the address field and if the two do not match, the area code may be corrected to correspond to the city and state information.

As there are likely to be carriers who do not offer call detail records via the Internet and some customers who must have it to get the full benefit of the present system, the present system also provides alternatives to getting the raw data (or service data). For example, as shown in FIG. 11, a small device (i.e., a remote probe or sensor similar to device 1100 shown in FIG. 1) may be inserted between the telephone cord and the jack, much as DSL filters are installed. A picture of an in-line DSL filter 1100 is shown below as representative of one possible appearance of the remote probe.

In certain embodiments, the remote sensor contains a single chip modem which includes a logical probe unit that performs Caller ID, Dual Tone Multi-Frequency (DTMF) detection and a logical transmission unit for dialing and transmitting data together with a limited computer or processing capability with memory. The device is powered by the telephone line and collects incoming and outgoing call detail records. It is configured (by software, firmware, or hardware or some combination thereof) to periodically dial a toll free number (or otherwise transfer) via the customer's phone line (or cable line or by suitable wireless transmission) to upload any information that it has collected and also receive any configuration changes.

In certain embodiments, the remote sensor may be a software component that can be loaded on a mobile phone or other wireless device so that usage data of the mobile phone or the wireless device can be collected and stored by the software component. The usage data may then be periodically transmitted by, for example, using the dialing features of the mobile phone or wireless device,

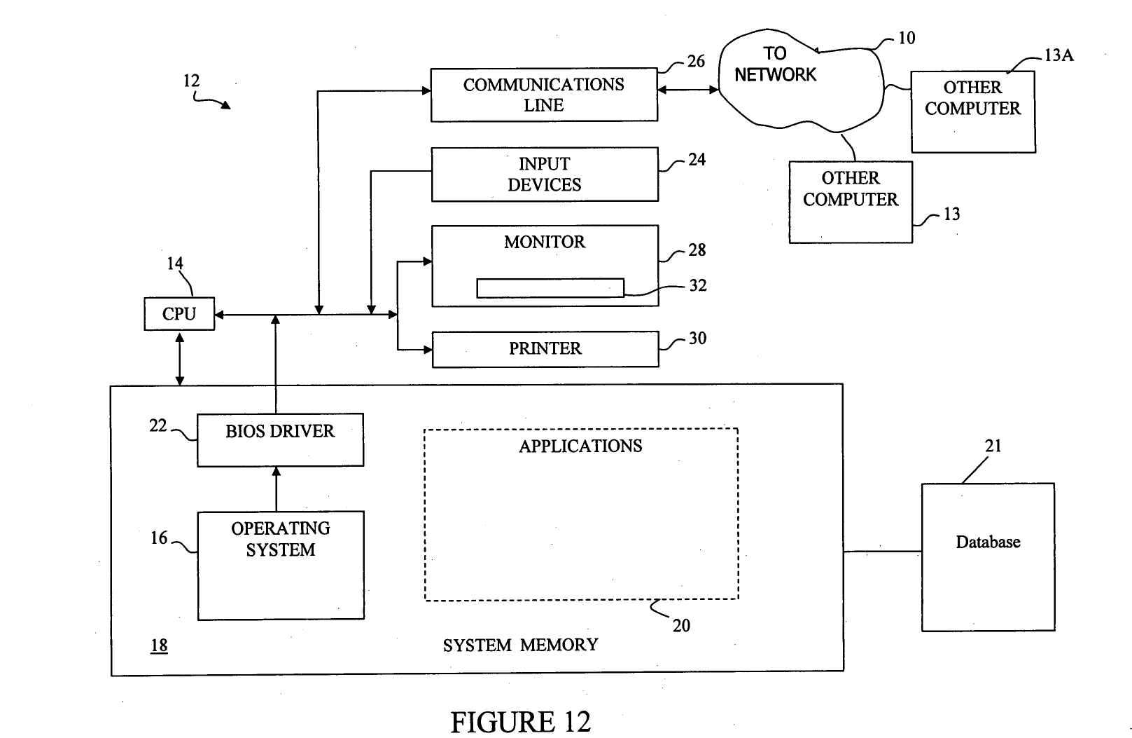

FIG. 12 illustrates the components of a generic computing system connected to a general purpose electronic network 10, such as a computer network. The computer network can be a virtual private network or a public network, such as the Internet. As shown in FIG. 6, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse or a keyboard 32, and output devices such as a printer 30 and a display monitor 28, and a permanent data store, such as a database 21. The computer system generally includes a communications interface 26, such as an Ethernet card, to communicate to the electronic network 10. Other computer systems 13 and 13A also connect to the electronic network 10 which can be implemented as a Wide Area Network (WAN) or as an internetwork, such as the Internet. In certain embodiments, such a computer system 12 can be used to implement the third party processing system discussed herein including programmed code that implements the logic discussed herein with respect to FIGS. 1-7. One skilled in the art would recognize that such a computing system maybe logically configured as an interface unit that implements the logic of FIGS. 1-4, an analysis unit that implements the logic of FIGS. 6-7 and an output unit that implements the logic of FIG. 5.

One skilled in the art would recognize that the foregoing describes a typical computer system 12 connected to an electronic network 10. It should be appreciated that many other similar configurations are within the abilities of one skilled in the art and it is contemplated that all of these configurations could be used with the methods and systems of the present invention. Furthermore, it should be appreciated that it is within the abilities of one skilled in the art to program and configure a networked computer system to implement the method steps of certain embodiments of the present invention, discussed herein.

In certain embodiments, the present invention also contemplates providing computer readable data storage means with program code recorded thereon (i.e., software) for implementing the method steps described herein. In certain embodiments, the present invention also contemplates the transmission of data signals having information embodied thereon which includes the results of the analysis as described earlier herein.

Other embodiments of the invention will be apparent to those skilled in the art from a consideration of the specification and the practice of the invention disclosed herein. It is intended that the specification be considered as exemplary only, with such other embodiments also being considered as a part of the invention in light of the specification and the features of the invention disclosed herein. Furthermore, it should be recognized that the present invention includes the methods disclosed herein together with the software and systems used to implement the methods disclosed here.

What is claimed is:

1. A computer implemented method of a third party retrieving and analyzing service data of a service used by a user, comprising:
accessing by the third party, over a network, the user's account with a service provider of the service to retrieve the service data from the service provider, wherein the third party is a party other than the service provider or the user;
analyzing the service data by the third party; and
providing, by the third party, results of analyzing the service data.

2. The computer implemented method according to claim 1, wherein the network is a public network.

3. The computer implemented method according to claim 1, further comprising a step of the third party receiving access information from the user and using the received access information to retrieve the service data.

4. The computer implemented method according to claim 1, further comprising a step of the third party generating access information on behalf of the user and using the generated access information to retrieve the service data.

5. The computer implemented method according to claim 1, further comprising receiving service data in a transmission initiated by a source of the service data.

6. The computer implemented method according to claim 1, further comprising the steps of:
receiving additional information related to the user or the service from a source other than the service provider; and
converting the service data and the additional information into a common format,
wherein the step of analyzing the service data comprises analyzing the service data and the additional information in the common format.

7. The computer implemented method according to claim 3, wherein the step of receiving access information comprises receiving an account number and password used by the user to access service data from the service provider.

8. The computer implemented method according to claim 6, wherein the step of receiving additional information comprises receiving enhancement information related to the service from the user.

9. The computer implemented method according to claim 6, wherein the step of receiving additional information comprises accessing public data related to the service data.

10. The computer implemented method according to claim 9, wherein the service is a telephone service, the service data comprises call details of the user, and the public data comprises a reverse lookup data identifying called telephone numbers of the calls in the call details.

11. The computer implemented method according to claim 9, wherein the public data comprises pricing information of the service provider and other competitors of the service provider.

12. The computer implemented method according to claim 9, wherein the service is a utility service, the service data comprises a usage of the utility service per time period, and the public data comprises a weather related parameter related to the time period.

13. The computer implemented method according to claim 9, wherein the service is travel, the service data comprises a listing of trips and time periods of the trips, and the public data comprises prices of trips during particular time periods provided by the service provider and other competitors of the service provider.

14. The computer implemented method according to claim 9, wherein the service is a healthcare related service, the service data comprises a listing and prices of the procedures used, and the public data comprises pricing information on the procedures used provided by a third party source.

15. The computer implemented method according to claim 9, wherein the service is automobile maintenance, the service data comprises maintenance and cost data of maintenance services performed the user, the public data comprises maintenance schedules and pricing data for the maintenance services.

16. The computer implemented method according to claim 9, wherein the service is a financial service, the service data comprises a listing of financial transactions and fees on the user's account, and the public data comprises public information related to the listed financial transactions and fees of other service providers.

17. The computer implemented method according to claim 1, wherein the analyzing step comprises using a quantitative analysis process to compare usage of the service by the user based on plans provided by other service providers or other plans provided by the service provider.

18. The computer implemented method according to claim 1, wherein the analyzing step comprises using artificial intelligence techniques with the service data and additional user input to determine an optimal service plan for the user.

19. The computer implemented method according to claim 18, further comprising automatically converting the user to the optimal service plan.

20. The computer implemented method according to claim 1, further comprising automatically receiving data related to usage of the service by the user from a source other than the service provider, wherein the step of analyzing the service data also analyzes the automatically received data.

21. The computer implemented method according to claim 20, wherein the source comprises a remote sensor that automatically collects data related to usage of the service and automatically transmits the collected data to the third party.

22. The computer implemented method according to claim 21, wherein the service is a telephone service and the remote sensor automatically collects call details and periodically transmits the call details to the third party.

23. A system for a third party retrieving and analyzing service data of a service used by a user, comprising:
an interface unit of the third party that accesses the user's account with a service provider of the service over a network and retrieves the service data from the service provider, wherein the third party is a party other than the service provider or the user;
an analysis unit, connected to the interface unit, that analyzes the service data; and
an output unit that receives analysis results from the analysis unit and provides the analysis results to the user.

24. The system according to claim 23, wherein the interface unit receives additional information related to the service from a source other than the service provider or the user.

25. The system according to claim 23, wherein the interface unit receives access information from the user and uses the access information to retrieve the service data from the service provider.

26. The system according to claim 24, wherein the analysis unit is configured to convert the service data and the additional information into a common format, and analyzes the service data and the additional information in the common format.

27. The system according to claim 23, wherein the interface unit receives enhancement information related to the service from the user.

28. The system according to claim 23, wherein the interface unit accesses public data related to the service data.

29. The system according to claim 23. wherein the analysis unit performs a quantitative analysis process to compare usage of the service by the user based on plans provided by other service providers or other plans provided by the service provider.

30. The system according to claim 23, wherein the analysis unit uses artificial intelligence techniques with the service data and additional user input to determine an optimal service plan for the user.

31. The system according to claim 30, wherein the output unit automatically converts the user to the optimal service plan.

32. The system according to claim 23, wherein the interface unit receives service data automatically collected by a remote sensor.

33. The system according to claim 32, wherein the remote sensor periodically transmits the automatically collected data to the third party and receives configuration information from the third party.

34. A computer readable medium having program code recorded thereon that, when executed on a computing system, enables a third party to retrieve and analyze service data of a service used by a user, the program code comprising:
code for accessing by the third party, over a network, the user's account with a service provider of the service and retrieving the service data from the service provider, wherein the third party is a party other than the service provider or the user;
code for the third party analyzing the service data; and
code for the third party providing results of analyzing the service data.

35. The computer readable medium according to claim 34, further comprising:
code for receiving additional information related to the user or the service from a source other than the service provider;
code for converting the service data and the additional information into a common format,
wherein the code for analyzing analyzes the service data and the additional information in the common format.

36. A computer implemented method of analyzing service data of a service used by a user, comprising:
providing, by the user, access information to access service data from a service provider of the service so that service data from the service provider is retrieved by a third party using the provided access information;
providing, by the user, additional information related to the service or the user; and
receiving an analysis result of the analysis of the service data and the additional information, which are both converted to a common format prior to the analysis, from the third party.

37. A remote sensor for automatically collecting and sending service data related to usage of a service by a user, comprising:
a probe unit that automatically detects service data related to usage of the service;
a memory unit that stores the detected service data; and
a transmission unit that transmits the stored service data.

38. The remote sensor according to claim 37, wherein the service comprises a telephone service, the probe unit is inserted between a telephone cord and a telephone jack, the service data comprises telephone call details, and the transmission unit comprises a modem.
